(19) United States
(12) Patent Application Publication
(10) Pub. No.: US 2010/0036751 A1
(43) Pub. Date: Feb. 11, 2010

(54) Architecture For Instantiating Information Technology Services

(76) Inventors: Erik Eidt, Campbell, CA (US); Mathias Salle, San Francisco, CA (US); Matthew Newman, West Linton (GB); Sameer Vaidya, Los Gatos, CA (US); Jack S. Walicki, Half Moon Bay, CA (US); Russell Daniels, Sunnyvale, CA (US); Christopher Peltz, Windsor, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/262,017

(22) Filed: Oct. 30, 2008

Related U.S. Application Data
(60) Provisional application No. 61/087,563, filed on Aug. 8, 2008.

(51) Int. Cl. G06Q 30/00; G06Q 10/00

(52) U.S. Cl. 705/27; 705/34

(57) ABSTRACT

Methods, systems, and computer program products are provided for information technology (IT) services lifecycle management. A services architecture provides a plurality of services that are capable of being ordered. A design service captures declarative specifications of services as service models. A catalog service receives the service model and combines the service models into a plurality of service offerings to provide a catalog of orderable services. An order configuration service receives an order for at least one orderable service selectable from the catalog of orderable services. An order processing service instantiates the at least one orderable service in two phases, thereby generating an instantiated ordered service. An order fulfillment service fulfills the order in accordance with the instantiated ordered service.

### CROSS-REFERENCE TO RELATED APPLICATION

This Utility Patent Application is based on and claims the benefit of U.S. Provisional Application No. 61/087,563, filed on Aug. 8, 2008, the contents of which are hereby incorporated by reference in their entirety.

### BACKGROUND OF THE INVENTION

Over the last few years, information technology (IT) organizations have increasingly adopted standards and best practices to ensure efficient IT service delivery. In this context, the IT Infrastructure Library (ITIL) has been rapidly adopted as the de facto standard. ITIL defines a set of standard processes for the management of IT service delivery organized in processes for Service Delivery (Service Level Management, Capacity Management, Availability Management, IT Continuity Management and Financial Management) and Service Support (Release Management, Configuration Management, Incident Management, Problem Management and Change Management). The Service Support processes, such as Configuration Management, Incident Management, and Configuration Management are some of the more common processes IT organizations have implemented to bring their service to an acceptable level for their businesses.

The implementation of ITIL processes has yielded significant results to IT organizations by defining interfaces between service providers and consumers, by clarifying the IT organizational structures, roles, and responsibilities, and by designing internal processes for the management of IT operations. IT Service Management (ITSM) is a process-based practice intended to align the delivery of IT services with the needs of the enterprise, while emphasizing benefits to customers. ITSM focuses on delivering and supporting IT services that are appropriate to the business requirements of the organization, and it achieves this by leveraging ITIL-based best practices that promote business effectiveness and efficiency. Thus, the focus of ITSM is on defining and implementing business processes and interactions there between to achieve desired results. IT services are typically built around the processes. For example, in a manufacturing application, the ITSM may provide services built around a build-to-order manufacturing process scenario. The ITSM architecture generally provides services that are capable of being directly instantiated. With a focus on processes, separation of concerns between the artifacts managed by the services may be a challenge in an ITSM environment.

### SUMMARY

Methods, systems, and computer program products are provided for services lifecycle management. A services architecture provides a plurality of services that are capable of being ordered. A design service captures declarative specifications of services as service models. A catalog service receives the service models and combines the service models into a plurality of service offerings to provide a catalog of orderable services. An order configuration service receives an order for at least one orderable service selectable from the catalog of orderable services. An order processing service instantiates the at least one orderable service in two phases, thereby generating an instantiated ordered service. An order fulfillment service fulfills the order in accordance with the instantiated ordered service.

### BRIEF DESCRIPTION OF THE DRAWINGS

Embodiments of the invention relating to both structure and method of operation may best be understood by referring to the following description and accompanying drawings:

FIG. 1A illustrates an exemplary structure of a model for IT services, according to an embodiment;

FIG. 1B describes a state transition diagram for a two-phase model instantiation process, according to an embodiment;

FIG. 2A illustrates an architecture for a runtime environment described with reference to FIG. 1A, according to an embodiment;

FIG. 2B illustrates a block diagram of a configure-to-order system to implement an architecture described with reference to FIG. 2A, according to an embodiment;

FIGS. 3A, 3B, and 3C illustrate in a tabular form an exemplary list of service operations supported by an architecture described with reference to FIGS. 2A and 2B, according to an embodiment;

FIG. 4 is a flow chart of a method for managing IT services, according to an embodiment; and

FIG. 5 illustrates a block diagram of a computer system, according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various modules, devices or components described herein may be implemented as hardware (including discrete components, integrated circuits and systems-on-a-chip ‘SoC’), firmware (including application specific integrated circuits and programmable chips) and/or software or a combination thereof, depending on the application requirements. The accompanying drawings may not to be drawn to scale and some features of embodiments shown and described herein may be simplified or exaggerated for illustrating the principles, features, and advantages of the disclosure.

The following terminology may be useful in understanding the present disclosure. It is to be understood that the terminology described herein is for the purpose of description and should not be regarded as limiting.

Architecture—A blueprint or basic infrastructure designed to provide one or more functions. M architecture used in an IT environment may typically include hardware, software and services building blocks that are designed to work with each other to deliver core functions and extensible functions. The core functions are typically a portion of the architecture, e.g., an operating system, which may not be modifiable by the user. The extensible functions are typically a portion of the architecture that has been explicitly designed to be customized and extended by the user as a part of the implementation process. For example, services oriented architecture (SOA) is a type of an architecture used for addressing the need for structuring IT services that lowers cost and enhances reusability.

Model—A model can be a representation of the characteristics and behavior of a system, element, solution, or service. A model as described herein captures the design of a particular IT system, element, solution, or service. The model can be a declarative specification of the structural, functional, non-functional, and runtime characteristics of the IT system, element, solution, or service. The instantiation of a model creates a model instance. Unlike object oriented (OO) theory, in which an instance object can be a slot space, the model instance can be a design space that may be capable of accommodating refinement.

IT artifact—An IT artifact refers to a tangible attribute or property of an IT system. Examples of an IT artifact may include hardware, software, documentation, source code, test apparatus, project plans, educational and marketing material, and similar others. The IT artifact may be available for external or internal use.

Separation of concerns—A technique for addressing different issues of a problem individually, thereby making it possible to concentrate on each issue separately. Applying this principle may result in a decrease in the complexity by dividing the problem into different smaller issues; support division of efforts and separation of responsibilities; and improve the modularity of IT systems or artifacts.

Service—Utility or benefit provided by a provider to a consumer. The provider and the consumer may vary by application and may include an enterprise, a business unit, a business process, an application, a third party, an individual, and similar others. Enterprise services may be provided in the course of conducting the enterprise business. IT services generally refer to any applications that enables the enterprise to provide utility or benefit by adding functionality to the IT infrastructure.

Service Model—A service model can be the representation of a service within a SOA. It defines the externally visible description, behavior, state, and operations available from a service to other services. As described herein, instantiation of a service model can be conducted in two phases—a binding phase and a grounding phase. The binding phase can be responsible for resolving dependencies between models. The grounding phase can be responsible for materializing the instances, e.g., by creating an IT artifact corresponding to-the specification defined in the service model instance.

Meta Model—A meta model (or metamodel) can be a description of a set of building blocks, constructs and rules that define the model itself.

System—One or more interdependent elements, components, modules, or devices that co-operate to perform one or more predefined functions.

Configuration—Describes a set up of elements, components, modules, devices, and/or a system, and refers to a process for setting, defining, or selecting hardware and/or software properties, parameters, or attributes associated with the elements, components, modules, devices, and/or the system.

Applicants recognize that it would be desirable to provide a services architecture that would include tools and techniques to initially design, reuse, maintain, and refine services during their entire lifecycle, thereby ensuring alignment between IT services and IT infrastructure. That is, it would be desired to provide IT service lifecycle management tools and techniques that would promote the development, capture, and subsequent reuse and refinement of reliable and scalable services. Applicants further recognize that it would be desirable that the separation of concerns between the artifacts managed by the services be based on roles, e.g., a designer or developer and an end user of services. Therefore, a need exists to provide improved tools and techniques to be used in the automation of IT services lifecycle management.

Systems and methods disclosed herein provide an architecture that is capable of designing and delivering IT services that are entered as a configure-to-order compared to a build-to-order provided by traditional ITSM services. An analogy may be made between a builder that is capable of building standard model homes that are orderable as a build-to-order home and an architect designed home that is capable of building a customized home in accordance with user specifications and that is orderable as a configure-to-order home. New features or functions of the configure-to-order home that were not included in the standard build-to-order home may be cataloged (with known price and delivery) and offered as re-usable features or functions that may be combined with existing model homes.

A Model for Information Technology (IT) Services

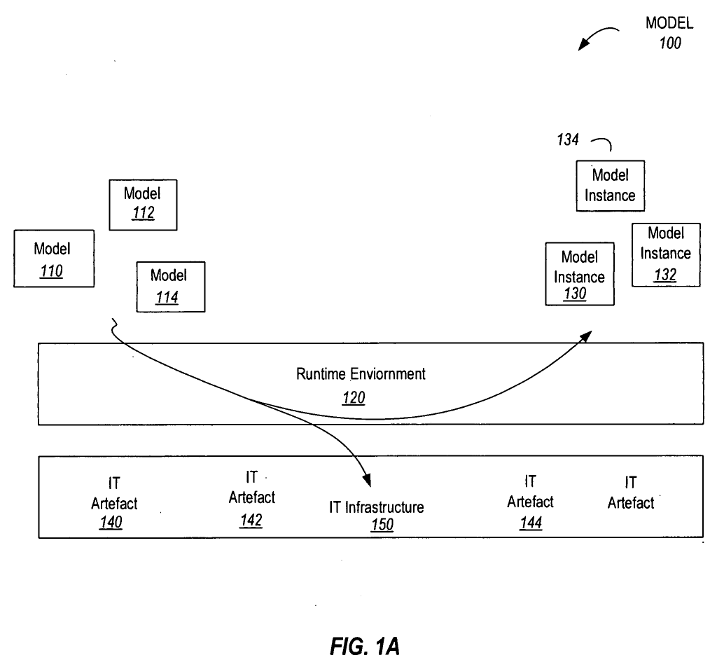

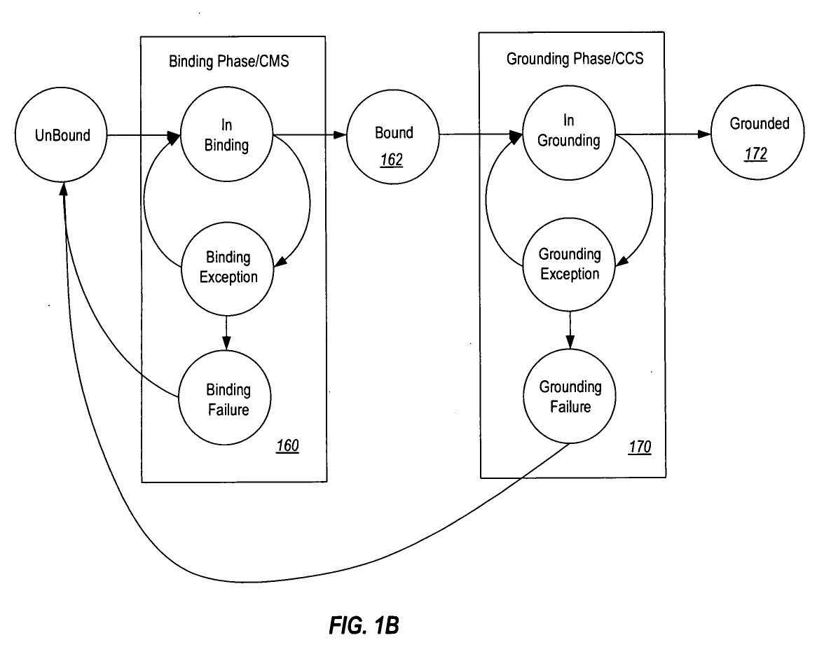

FIG. 1A illustrates an exemplary structure of a model 100, according to an embodiment. The model 100 captures the design of a particular IT element or solution, e.g., IT services captured as a service model. As described earlier, a service model can be the representation of a service within a SOA. It defines the externally visible description, behavior, state, and operations available from a service to other services. The model 100 includes one or more models 110, 112 and 114 capable of being instantiated in a runtime environment 120 to generate corresponding model instances 130, 132 and 134 and corresponding IT artifacts 140, 142, and 144 generated in an IT infrastructure 150. Thus, the instantiation of a model results in a generation of a virtual runtime object, e.g., the model instance, and also results in a generation of a real, tangible IT artifact in the IT infrastructure 150. The IT infrastructure 150 may be a data center that includes hardware, software, communications, applications, services and similar other components to provide IT functions. The runtime environment 120 includes services that process the models 110, 112 and 114.

The model 100 can be a declarative specification of the structural, functional, non-functional, and runtime characteristics of an IT system. That is, the model 100 may use declarative programs that may include expressions, relationships, or statements of truth. The declarative programs may not include variables. Closely equivalent to the concept of a class in Object Oriented (OO) theory, the model 100 supports the principles of encapsulation and hiding of implementation detail. As in OO, the model 100 also supports recursive composition. Also as in OO theory, in which a class instantiation results in an object, the instantiation of a model results in the creation of a model instance. However, unlike OO, in which an instance object is a slot space, the model instance, e.g., each of model instances 130, 132 and 134, can be a design space that can accommodate refinement. In addition, as described earlier, a corresponding IT artifact becomes associated with the model. In the depicted embodiment, the bi-instantiation process for the models 110, 112 and 114 is desirable to not only create a virtual runtime object that represents that particular instance of the model but in addition also generate an IT component or system in the real, tangible, IT Infrastructure 150. A relationship between a model instance, e.g., one of the model instances 130, 132 and 134, and an IT artifact, one of the IT artifacts 140, 142, and 144, is therefore homomorphic. That is, one represents the other and a change in one is reflected in the other. Additional description of the two-phase instantiation process for a model is described with reference to FIG. 1B.

Referring back to FIG. 1A, in order to support initial design, reuse, maintain, and refinement during the entire lifecycle of the models, the model 100 supports the following exemplary properties (among others): refinement, variability, polymorphism, composability, import, association, constructors, operations, deployment, monitors, declarative modeling language, and best practice. Recursive composability enables a designer to depend on and leverage existing designs in order to define or create new ones, which in turn are available to others to reuse. Refinement allows the instantiation process to be multi-step, thereby allowing for a greater flexibility in the model design. Encapsulation (also referred to as information hiding), use of clear boundary between the visibility into the internal design of a model and its publicly available characteristics, supports inter-model dependencies that allow changes to the internal specification without requiring changes in the model user. Characterization enables the expressing the outward nature of the model in terms that are directly relevant to the consumer of the model instead of in terms relevant to the implementer. Variation enables capturing variations in a single model. A model may be defined under several variations of its characteristics to reflect specific changes to the underlining design. Capturing these variations in a single model avoids combinatorial explosion of models and supports better model reuse. Declaration enables definition of models using declarative specifications. The models are defined in terms of their association to underlying design instead of as process steps for instantiation using programming code. Use of statements of truth to define the models reduce errors due to interpretation or avoid use of languages have meaning only during execution in the intended environment.

The models 110, 112 and 114 can be defined by a meta model, thereby enabling the models 110, 112 and 114 to be translated into other modeling languages. Thus, model 100 enables easy translation of user-defined models to other forms (both model-oriented and script-oriented forms) thereby enhancing its flexibility. In addition, model 100 provides the tools and techniques for the replacement of one modeling language with other modeling languages and for the coexistence of multiple structural modeling languages. As described herein, a meta model is a model that further explains or describes a set of related models. Specifically, the meta model includes an explicit description (of constructs and rules) of how a domain-specific model is built.

The model 100 may be specified by using various modeling languages including, among others, a unified modeling language (UML), the Resource Description Framework (RDF), Extensible Markup Language (XML) Schema, XML Metadata Interchange (XMI), and Java languages or a combination thereof. The RDF may include extensions such as RDF Schema and languages such as the RDF Ontology Web Language (RDFIOWL).

The concept of refinement, which may be an example of an extensible feature of the model 100, allows a smooth multi-valued transition from a model to a model instance. Whereas classic modeling approaches [OO, CIM, SML, UML] are based on a single value slot mechanism for instance creation, refinement can be based on a linked list approach that enables multi-slot capabilities for model elements. In addition, substitution can be supported, similar to XML Schema. A refinable object or a refinable model element, is any object/element that extends a refinable construct. The refinable construct carries metadata including: 1) allowRefinement: a boolean attribute that can be used to stop the refinement process, 2) timestamp: a timestamp that record the time at which the refinement occurred, and 3) tag: a tag that records extra information such as purpose of the refinement or similar other.

FIG. 1B illustrates a state transition diagram for a two-phase model instantiation process, according to an embodiment. The instantiation of a model, e.g., any one of the models 110, 112 and 114, can be conducted in two phases: a binding phase 160 and a grounding phase 170. In an exemplary, non-depicted embodiment, the binding phase 160 may be implemented in a binding phase engine and a ground phase 170 may be implemented in a grounding phase engine. In the binding phase 160 inter-model dependencies, e.g., made by a model to other models, can be resolved. An output of the binding phase 160 is a bound model instance 162. Model instances 130, 132, and 134 are examples of the bound model instance 162. The binding phase 160 may be viewed to provide a dynamic linking between model instances. Dependencies to other models can be abstract, refined or very specific and the binding phase 160 resolves these types of model references by reusing existing instances or creating new instances. The binding phase can be inherently recursive in that the binding of a dependent model can itself trigger a binding of its dependencies.

In the grounding phase 170, the bound model instance 162 can be materialized to generate a bound and grounded model instance 172. The materializing includes creating an IT artifact corresponding to the specification defined in the model instances. This can be achieved by recursively traversing the instance tree and creating, when appropriate, the corresponding artifacts in the IT infrastructure. IT artifacts 140, 142, and 144 are examples of a bound and grounded model instance 172.

An Architecture for a Runtime Environment

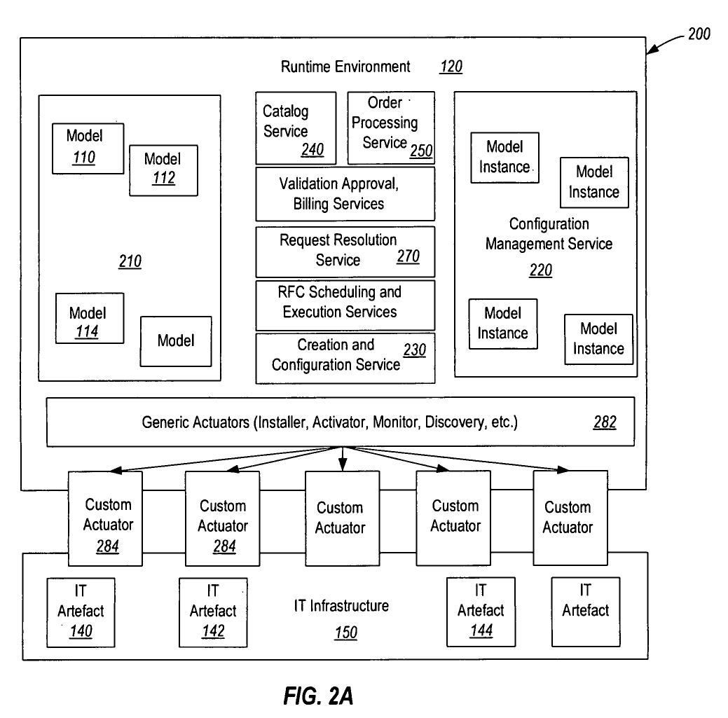

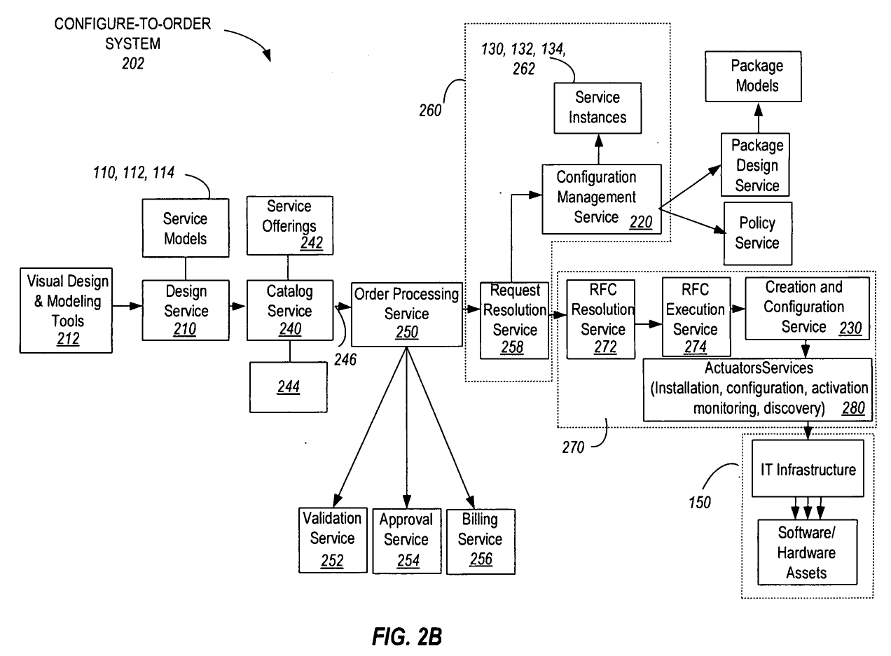

FIG. 2A illustrates an architecture 200 for a runtime environment 120 described with reference to FIG. 1A, according to an embodiment. The architecture 200 can be deployed to provide e-commerce for IT services. That is, the architecture 200 may be deployed as a configure-to-order business system in which a set of predefined models of IT systems are offered to customers (may include internal or external users, clients and similar others). FIG. 2B illustrates a block diagram of a configure-to-order system 202 to implement an architecture 200 described with reference to FIG. 2A, according to an embodiment.

Referring to FIGS. 2A and 2B, the predefined models are for IT services. It is understood that the models may be expressed for other aspects of IT within an enterprise. The architecture 200 includes a design service 210 operable to generate models 110, 112 and 114. The design service 210 may include design tools 212 and techniques (such as declarative programming) available to a designer or an architect of IT services to manage the lifecycle of the models from initial design to cataloging to refinement In a particular embodiment, the design service 210 can be operable to capture declarative specifications of services as a service model.

A catalog service 240 can be operable to store a plurality of service offerings 242. The plurality of service offerings 242 are models of services that are cataloged and are orderable by a customer. The catalog service 240 communicates with the design service 210 to access one or more service models that are new and not been previously cataloged. The service models may include modifications or refinements made to existing models included in the plurality of service offerings 242. The one or more service models generated by the design service 210 are combined into the plurality of service offerings 242 to provide a catalog of orderable services 244.

End users may access the features of the configure-to-order system 202 through the catalog service 240 and an order processing service (OPS) 250 to browse, search, select, configure, and order the type of service model to be created and ordered or the type of changes desired to an existing model. In order to simplify the user interface, the catalog service 240 may filter model information provided to the user. That is, complex details about the model and its methods and properties, which may be provided to a designer or an architect, may be hidden from the user, thereby simplifying the user interface. For example, complex details of a blade server model having several processors arranged as a cluster may be presented to the user as a normal, high, and non-stop availability selection. Included in the information provided to the user is price and delivery associated with the order. In a particular embodiment, at least one orderable service 246 can be selectable from the catalog of orderable services 244 for placing an order. The selection may be performed by one of a user and an application program. In a particular embodiment, the OPS 250 can include a set of intermediate services for performing validation 252, approval 254 and billing 256 of the end user order.

An order instantiation service 260 is coupled to receive the order (that has been validated and approved) for the at least one orderable service 246 from the OPS 250. Specifically, upon validation and approval of the order by the OPS 250, a request resolution service 258 can be triggered to initiate further processing of the order by the order instantiation service 260. The order instantiation service 260 can be operable to instantiate the at least one orderable service 246, thereby generating an instantiated ordered service 262. The order instantiation service 260 includes a configuration management service (CMS) 220 operable to perform the binding phase 160 and generate the instantiated ordered service 262. The CMS 220 includes tools and techniques for implementing the binding phase 160 of the two-phase instantiation process as well the management of the model instances, e.g., model instances 130, 132 and 134. The CMS 220 generates a service instance corresponding to each order.

An order fulfillment service 270 can be operable to fulfill the order in accordance with the instantiated ordered service 262. The order fulfillment service 270 can include a request for change (RFC) scheduling 272 and a RFC execution service 274 for the sequencing of the various orders in the runtime environment 120. The order fulfillment service 270 includes a creation and configuration service (CCS) 230 operable to perform the grounding phase 170 of instantiated ordered service 262. The CCS 230 includes tools and techniques for the implementation of the grounding phase 170, which includes creation of IT artifacts (such as artifacts 140, 142, and 144) in the IT infrastructure 150.

The connection between the runtime environment 120 and the IT infrastructure 150 can be performed through an actuator service 280. The actuator service 280 may include two layers, a generic actuator 282 and a custom actuator 284. In an embodiment, more than one generic actuators and more than one custom actuators may be included. The generic actuator 282 can be operable to dispatch instances to the custom actuator 284. For example, a server model may be configured to define deployment and provisioning information related to a rapid deployment pack (RDP) deployer. A deployment request can be triggered from the CCS 230 to a generic installer included in the generic actuator 282, which in turn will search for a specialized deployer that can handle RDP deployment information. This technique enables a loose coupling between the runtime environment 120 and the IT infrastructure 150 and offers a high level of customization. That is, the architecture 200 provides IT service lifecycle management tools and techniques that promote the development, capture, and subsequent reuse and refinement of reliable and scalable services. In addition, the architecture 200 further provides the separation of concerns between the artifacts managed by the services be based on roles, e.g., a designer or developer (e.g., user of the design service 210) and an end user of services (e.g., user of the catalog service 240).

In a particular embodiment, the architecture 200 is scalable to be deployed in applications having varying scope and complexity starting from a blade server to a large scale, enterprise-wide IT service. In an exemplary non-depicted embodiment, SmartRack can be an exemplary name of an application of the architecture 200 that combines hardware, management software, and applications to provide customers with a unique, systematic experience to IT conceptualization, delivery, and consumption. This can be accomplished by both shipping the management software embedded with the hardware and by providing a systematic way of modeling applications that can be deployed. Once a SmartRack is powered on, the main point of user contact can be the catalog service. Service offerings can be presented to the user along with their available configuration options, each of which are characterized in terms of the resulting service's attributes, the cost, and time to build. Service offerings may be dynamically generated views based on a set of rich models, stored in the design service, that weave together the structural, functional, non functional, and runtime characteristics of a service using a set of best practices. In a typical deployment, SmartRacks may be configured with pre-populated foundation models. Other models may be either purchased and downloaded from Hewlett Packard Development Company, L.P. (HP) or 3rd parties, or developed in house by customers. Once the appropriate service offering is selected and ordered, it can be sent to the management services that will process it and ground (materialize) it using a set of installer services. If specified in the model, once grounded, the various elements of the model are automatically monitored by monitoring service(s). SmartRacks may be deployed in stand alone mode when a customer only desired one rack of blades (SME/SMB). In addition, through its built-in federation capability, several SmartRacks can be combined together providing a unified management experience for the customer. Lastly, SmartRack, through its open SOA architecture and service proxy technology, can support the substitution of its services by external services allowing SmartRacks to reuse existing management software assets of the enterprise, and, allow more than one SmartRacks to be combined so that they are both managed through one user interface (instead of each being independent).

In an exemplary, non-depicted embodiment, the architecture 200 can be a scaled up to a full enterprise architecture that puts services as the key economic principle of value transfer between business (or enterprise) and IT. IT may provide “IT- consumed services” to operate itself (tools and techniques to improve internal productivity). These are things like service desk technologies, change management systems, blades, facility services, networks, employees, legal services. These services can be thought of as the tooling of IT, and together they can be used to create the IT deliverable, the “IT-delivered service.” IT-delivered services can be created by IT for use by the business. Examples might include a consumer credit check service, employee expense reporting service, new employee set up service, a QA lab rental service, a private network and similar others. The IT delivered services can be delivered as an economic unit of value to the business. In other words, they are designed, constructed and delivered in a way such that the lines of business see its value, and are willing and able to purchase them. In fact, the IT-delivered service transforms into to a business-consumed service at the moment of payment. This payment can be indicative of the value as perceived the consumer, which in this case is the line of business. The IT-delivered services in and of themselves render IT as a service provider.

IT services provided to a business may be defined starting with a name (e.g. sales forecasting service), followed by a description (e.g. daily worldwide sales pipeline report and analysis for senior sales management). Every service may need additional artifacts and descriptors that are associated with the ongoing integrity of the service. These may include the service level agreements (SLAs) so that IT and the business are aligned around performance and availability, a logical and physical view of the configuration items that underpin the service, a view or dependant services, documentation, a continuity plan, knowledge entries, subscriber entitlements, and security and access provisions. The IT services may be defined by defining a service-line category structure. Just like consumer goods providers have product line categories, so do IT services. They may include employee services, application services, network services, others. Similar to consumer products, IT services may be established with a price, value and business outcome for each service. In order to qualify as an IT-delivered service, it is desirable that there is an associated, measurable business outcome. The IT services can be made available through a customer catalog service by developing a consistent way to articulate both a public (business-facing) and private (IT-facing) characterization of each service. Service components can be reused whenever possible. Consistent design criteria for both the public and private facing characterization of the service can directly impact the process automation effort required to instantiate, monitor and manage the service throughout its lifecycle. Service visibility and integrity can be maintained at all levels including management stakeholders like the service desk, problem managers, change managers, application owners, IT finance managers, business relationship managers are able to view and manage activities around the service definition in a consistent way. When scaling up to the enterprise-wide architecture, IT provided services are defined as models and the services of the runtime environment are the embodiments of the IT consumed services.

Exemplary Services Supported by the Architecture 200

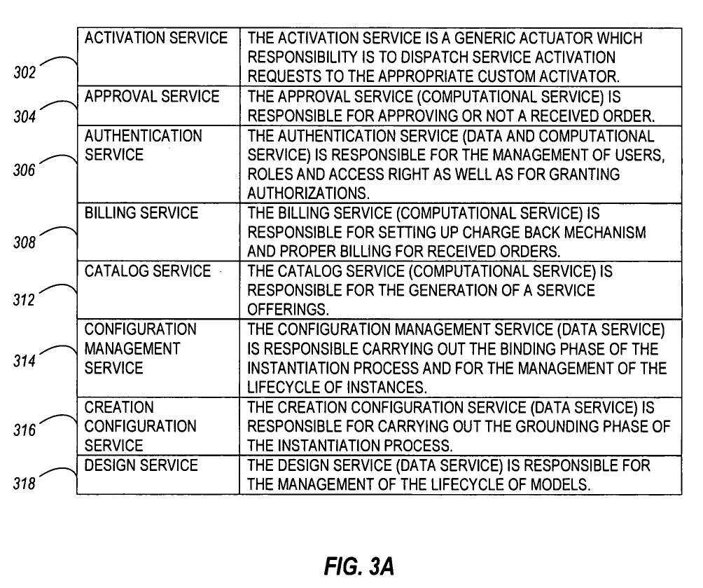

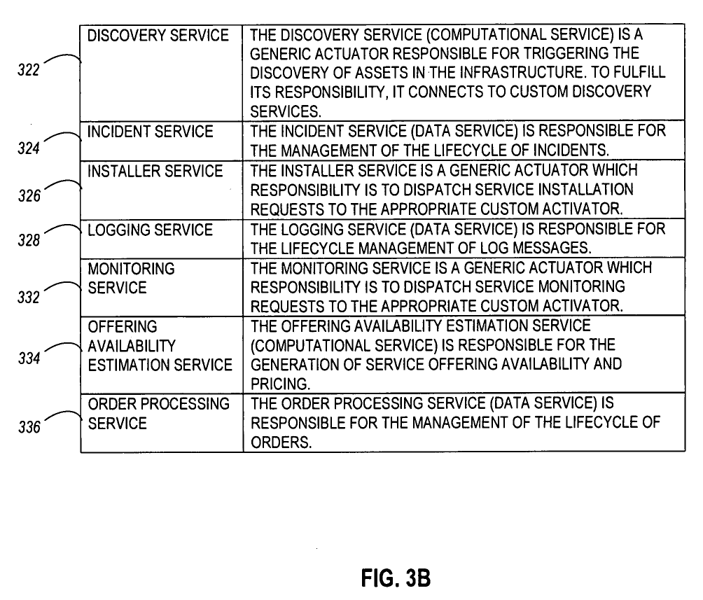

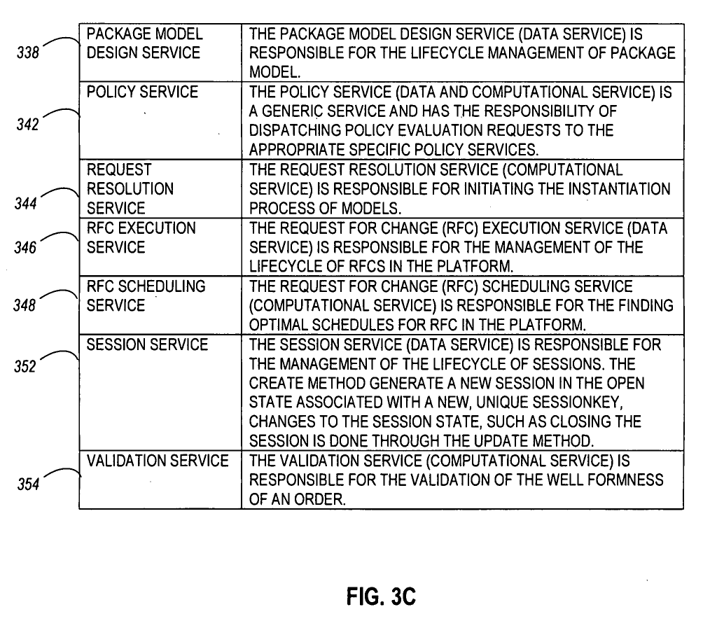

FIGS. 3A, 3B, and 3C illustrate in a tabular form an exemplary list of service operations supported by the architecture 200 described with reference to FIGS. 2A and 2B, according to an embodiment. In accordance with the principles of Service Oriented Architecture (SOA), components in the architecture 200 are conceived as services, that is, independent units of functionality with well specified interfaces and data models. The list of services may be described to perform a generic service (for aggregating data across data services), a data service (for the management of lifecycle of specific data models), a computational service (for the execution of business logic) or a combination thereof. An activation service 302 can be a generic actuator with responsibility to dispatch service activation requests to an appropriate custom activator. An approval service 304 (computational service) can be responsible for approving or not approving a received order. An authentication service 306 (data and computational service) can be responsible for the management of users, roles and access rights as well as granting authorizations. A billing service 308 (computational service) can be responsible for setting up charge back mechanism and proper billing for received orders.

A catalog service 312 (computational service) can be responsible for the generation of a service offerings. A configuration management service 314 (data service) can be responsible carrying out a binding phase of the instantiation process and for the management of the lifecycle of instances. A creation configuration service 316 (data service) can be responsible for carrying out a grounding phase of the instantiation process. A design service 318 (data service) can be responsible for the management of the lifecycle of models.

A discovery service 322 (computational service) can be a generic actuator responsible for triggering the discovery of assets in the infrastructure. To fulfill its responsibility, discovery service 322 can connect to custom discovery services. An incident service 324 (data service) can be responsible for the management of the lifecycle of incidents or events. An installer service 326 can be a generic actuator responsible to dispatch service installation requests to the appropriate custom activator. A logging service 328 (data service) can be responsible for the lifecycle management of log messages.

A monitoring service 332 can be a generic actuator which has the responsibility to dispatch service monitoring requests to the appropriate custom activator. An offering availability estimation service 334 (computational service) can be responsible for the generation of service offering availability and pricing. An order processing service 336 (data service) can be responsible for the management of the lifecycle of orders. A package model design service 338 (data service) can be responsible for the lifecycle management of package model.

A policy service 342 (data and computational service) can be a generic service and has the responsibility of dispatching policy evaluation requests to the appropriate specific policy services. A request resolution service 344 (computational service) can be responsible for initiation of the instantation process of models. A request for change (RFC) execution service 346 (data service) can be responsible for the management of the lifecycle of RFCs in the platform. A RFC scheduling service 348 (computational service) can be responsible for the finding optimal schedules for RFC in the platform.

A session service 352 (data service) can be responsible for the management of the lifecycle of sessions. The create method generate a new session in the open state associated with a new, unique SessionKey. Changes to the session state, such as closing the session can be done through the update method. A validation service 354 (computational service) can be responsible for the validation of an order.

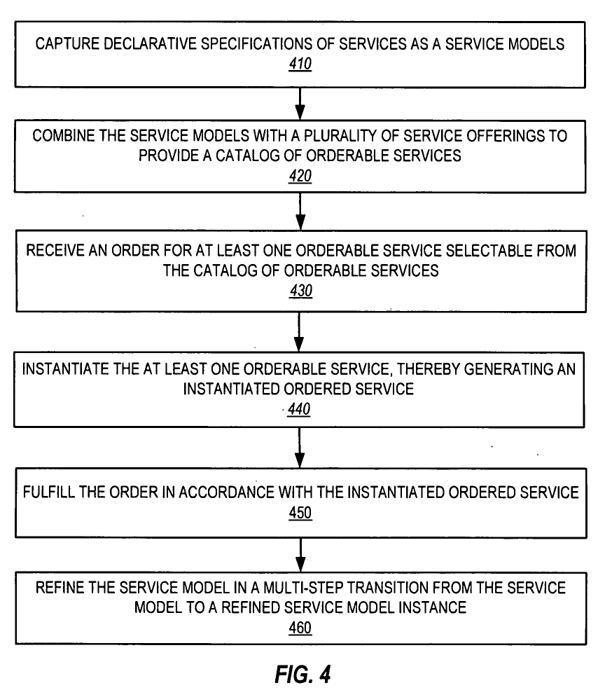

FIG. 4 is a flow chart of a method for managing IT services, according to an embodiment. In a particular embodiment, the method may be used to manage the model 100 described with reference to FIGS. 1A and 1B. In an embodiment, the method may be used to manage IT services provided by the architecture 200 deployable in an e-commerce environment. At step 410, declarative specifications of the services are captured as a service models. At step 420 the service models can be combined into a plurality of service offerings to provide a catalog of orderable services. At step 430, an order can be received for at least one orderable service selectable from the catalog of orderable services. At step 440, the at least one orderable service can be instantiated, thereby generating an instantiated ordered service. At step 450, the order can be fulfilled in accordance with the instantiated ordered service.

It is understood, that various steps described above may be added, omitted, combined, altered, or performed in different orders. For example, a step may be added to refine the service models. At step 460, the service models can be refined, the refining including a multi-step transition from the service models to a refined service model instance.

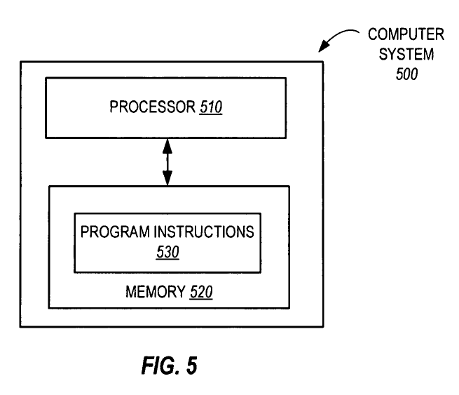

FIG. 5 illustrates a block diagram of a computer system 500, according to an embodiment. The computer system 500 includes a processor 510 coupled to a memory 520. The memory 520 is operable to store program instructions 530 that are executable by the processor 510 to perform one or more functions. It should be understood that the term “computer system” is intended to encompass any device having a processor that is capable of executing program instructions from a memory medium. In a particular embodiment, the various functions, processes, methods, and operations described herein may be implemented using the computer system 500. For example, the model 100, the architecture 200, the configure-to-order system 202 and similar others may be implemented using the computer system 500.

The various functions, processes, methods, and operations performed or executed by the system 500 can be implemented as the program instructions 530 (also referred to as software or simply programs) that are executable by the processor 510 and various types of computer processors, controllers, central processing units, microprocessors, digital signal processors, state machines, programmable logic arrays, and the like. In an exemplary, non-depicted embodiment, the computer system 500 may be networked (using wired or wireless networks) with other computer systems.

In various embodiments the program instructions 530 may be implemented in various ways, including procedure-based techniques, component-based techniques, object-oriented techniques, rule-based techniques, among others. The program instructions 530 can be stored on the memory 520 or any computer-readable medium for use by or in connection with any computer-related system or method. A computer-readable medium is an electronic, magnetic, optical, or other physical device or means that can contain or store a computer program for use by or in connection with a computer-related system, method, process, or procedure. Programs can be embodied in a computer-readable medium for use by or in connection with an instruction execution system, device, component, element, or apparatus, such as a system based on a computer or processor, or other system that can fetch instructions from an instruction memory or storage of any appropriate type. A computer-readable medium can be any structure, device, component, product, or other means that can store, communicate, propagate, or transport the program for use by or in connection with the instruction execution system, apparatus, or device.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, a few specific examples of data models are described. The illustrative system for IT service models can be used with any suitable data models. The illustrative techniques may be used with any suitable data processing configuration and with any suitable servers, computers, and devices. In the claims, unless otherwise indicated the article “a” is to refer to “one or more than one”.

What is claimed is:

1. A computer system comprising:
a computer processor; and
logic instructions on tangible computer readable media and executable by the computer processor to cause the computer processor to provide:
a design service operable to capture declarative specifications of services as a service model;
a catalog service operable to receive the service model from the design service and combine the service model into a plurality of service offerings to provide a catalog of orderable services;
an order processing service operable to configure an order for at least one orderable service selectable from the catalog of orderable services;
an order instantiation service operable to instantiate the at least one orderable service, thereby generating an Instantiated ordered service;
an order fulfillment service operable to fulfill the order in accordance with the instantiated ordered service.

2. The system according to claim 1 further comprising logic instructions to cause the computer processor to provide:
a configuration management service (CMS) included in the order instantiation service, the CMS being operable to execute a binding phase to generate the instantiated ordered service; and
a creation configuration service (CCS) included in the order fulfillment service, the CCS being operable to execute a grounding phase to generate an IT artifact to fulfill the order.

3. The system according to claim 2 further comprising logic instructions to cause the computer processor to automatically reflect a change made in one of the IT artifact and the instantiated ordered service, in the other.

4. The system according to claim 1 further comprising logic instructions to cause the computer processor to provide:
an actuator service included in the order fulfillment service, the actuator service being operable to link the runtime environment with an information technology (IT) infrastructure capable of fulfilling the order.

5. The system according to claim 1 further comprising logic instructions to cause the computer processor to provide:
the order being configurable by one of a user and an application program.

6. The system according to claim 1 further comprising logic instructions to cause the computer processor to provide:
the order including a price and a delivery schedule.

7. The system according to claim 1 further comprising logic instructions to cause the computer processor to provide:
the service model being capable of refinement, the refinement including a multi-step transition from the service model to a refined service model instance.

8. The system according to claim 1 further comprising logic instructions to cause the computer processor to provide:
the service model being a meta model configured to include a plurality of properties, the plurality of properties including refinement, variability, polymorphism, composability, import, association, constructors, operations, deployment, monitors, declarative modeling language, and best practice.

9. The system according to claim 1 further comprising logic instructions to cause the computer processor to provide:
the order processing service including an intermediate service operable to validate, approve, and bill the order.

10. The system according to claim 1 further comprising logic instructions to cause the computer processor to provide:
the order processing service triggering a request resolution service operable to initiate the order instantiation service.

11. A method for managing services:
capturing declarative specifications of the services as service models;
combining the service models into a plurality of service offerings to provide a catalog of orderable services;
receiving an order for at least one orderable service selectable from the catalog of orderable services;
instantiating the at least one orderable service, thereby generating an instantiated ordered service;
fulfilling the order in accordance with the instantiated ordered service, thereby generating an information technology (IT) artifact.

12. The method according to claim 11 further comprising:
the instantiating occurring in two phases, a first phase to resolve model dependencies and a second phase to generate an artifact corresponding to the specifications.

13. The method according to claim 12 further comprising:
refining the service models, the refining including a multi-step transition from the service models to a refined service model instance.

14. The method according to claim 13 further comprising:
the refining including incorporating best practices to update the service models.

15. The method according to claim 12 further comprising:
changing one of the artifact and the instantiated ordered service to automatically change the other.

16. A computer program product for managing services lifecycle comprising:
logic instructions stored on a computer readable storage media, the logic instructions being executable by a computer processor to cause the computer processor to:
capture declarative specifications of the services as service models;
combine the service models into a plurality of service offerings to provide a catalog of orderable services;
receive an order for at least one orderable service selectable from the catalog of orderable services;
instantiate the at least one orderable service, thereby generating an instantiated ordered service; and
fulfill the order in accordance with the instantiated ordered service.

17. The computer program product of claim 16 further comprising:
logic instructions executable by the computer processor to cause the computer processor to:
perform the instantiation in two phases, a first phase to resolve model dependencies and a second phase to generate an artifact corresponding to the specifications.

18. The computer program product of claim 17 further comprising:
logic instructions executable by the computer processor to:
refine the artifact to refine the service models, the refining of the artifact including a multi-step transition from the service models to a refined service model instance.

19. The computer program product of claim 18 further comprising:
logic instructions executable by the computer processor to:
incorporate best practices in the refining of the artifact to update the service models.

20. The computer program product of claim 17 further comprising:
logic instructions executable by the computer processor to:
change one of the artifact and the instantiated ordered service to automatically change the other.
